(19) United States
(12) Patent Application Publication
(10) Pub. No.: US 2014/0142221 A1
(43) Pub. Date: May 22, 2014

(54) Weighting Agent for Use in Subterranean Wells

(71) Applicants: Phillip William Bowles, Cornwall (GB); Paul Reid, Tavistock (GB); Nicholas John Goodwin Wilshaw, Tregony (GB)

(72) Inventors: Phillip William Bowles, Cornwall (GB); Paul Reid, Tavistock (GB); Nicholas John Goodwin Wilshaw, Tregony (GB)

(73) Assignee: Fumi Minerals Limited, Truro, Cornwall (GB)

(21) Appl. No.: 14/113,049

(22) PCT Filed: Apr. 9, 2012
(86) PCT No.: PCT/GB2012/000371

§ 371 Date: Nov. 6, 2013

(30) Foreign Application Priority Data
Apr. 21, 2011 (GB) 1106780.8

(51) Int. Cl. C09K 8/48

(52) U.S. Cl. CPC C09K 8/48
USPC 524/6; 524/423

(57) ABSTRACT

A weighting agent composition for use in a cement slurry for downhole operations in a subterranean well, the composition comprising a finely divided solid weighting agent; and a dispersant comprising a sulphonic acid, salt or derivative thereof, the sulphonic acid having the general formula I:

-[A(OSOO⁻M⁺)-B-A′(OSOO⁻M⁺)]ₙ- (I)

wherein A and A′ are each an aromatic moiety; B is an aliphatic moiety; OSOO⁻M⁺ is a solubilising group consisting of sulphonic acid, a salt or derivative thereof; and n is an integer of at least 2. The composition is of particular use in formulating a cement slurry for use in a downhole cementing operation. There is also provided a method of preparing a finely divided weighting agent using the sulphonic acid of formula I, a cement formulation comprising the composition and a method of cementing a subterranean well.

The present invention relates to weighting agents for preparing cement slurries for use in subterranean wells. The weighting agents find particular application in wells drilled for the production of oil and gas. The weighting agents find further use in other subterranean wells, such as water wells and geothermal wells. The present invention further relates to a method of preparing the aforementioned weighting agents and to their use in subterranean well operations.

In the drilling and completion of subterranean wells (hereinafter simply referred to as ‘wells’), pipes or casings, typically of steel, are used to line the well. The casing is lowered into position within the well. To secure the casing in position in the well, a cement slurry is pumped into the well through a pipe located within the casing. The cement slurry leaves the pipe and is forced into the annular space between the casing and the rock formation in which the well has been drilled. Once in place in the annulus between the casing and the rock formation, the cement is allowed to set, thereby forming a strong solid of low permeability. One purpose of the cement is to provide a barrier preventing fluids from within the rock formation migrating from one rock stratum to another through the annular cavity. Such use of the cement is known in the art as ‘zonal isolation’. Further, the cement, once set, prevents fluids from the rock formation passing up the annular cavity to the surface. In addition, the cement performs additional functions, such as providing a mechanical support for the casing and preventing corrosion of the casing by fluids in the rock formation.

The properties required for the well cements vary according to such factors as the type of well, its depth and the nature and properties of the rock formation in which the well is formed. In addition, the properties required of the cement will also depend upon the fluids held in the rock formations, in particular the fluid pressure (known in the art as the ‘pore pressure’), the temperature of the fluids and the nature of the fluids present and being produced from the well. The properties required for the cement are typically determined in the planning stage of the well and are provided and/or varied as required by additives included in the cement formulation. In particular, additives are included into the cement formulation to vary such properties as the time taken for the cement to set, the compressive and/or tensile strength of the cement, the density of the cement formulation. In addition, additives are included in the formulation to vary the rheology of the cement slurry.

Cement slurries having a density of up to about 17 pounds per gallon (ppg), or a specific gravity (s.g.), of about 2.0 can be prepared using powdered cement and water in appropriate relative amounts. The slurry will include other additives well known in the art. Higher density slurries, up to a density of about 17.4 ppg, or 2.09 s.g., are achieved by including silica sand as a weighting component in the slurry. However, it is frequently the case that cement slurries with still higher densities are required in wells. For example, slurries with higher densities are required when the hydrostatic pressure required in the well to retain the rock formation and the fluids contained therein exceeds that possible using the aforementioned slurry formulations. In such cases, it is known to use high density solids as weighting agents, to increase the density of the cement slurry. Such weighting agents known in the art include sulphates, such as barium sulphate (for example barite), oxides, such as iron oxides (for example hematite), iron titanium oxides (for example ilmenite) and manganese oxides (for example manganese tetroxide). Such weighting agents are commercially available and are widely used, in particular in the formation and completion of oil and gas wells.

The present invention is particularly concerned with weighting agents for use in cement slurries for wells, where the density of the cement slurry is required to be greater than can be achieved with just the combination of cement and water alone

To be acceptable for use as a weighting agent, a high density solid material should satisfy certain requirements. First, the inclusion of the weighting agent in the cement slurry should not adversely affect the strength of the cement formulation when finally set within the well. Further, the presence of the weighting agent should not affect the set time of the cement slurry to an extent that cannot be controlled to achieve a set time within the required limits using such additives as set retarders or set accelerators. The weighting agent should not adversely affect the hydration reaction of the cement during setting.

It is also important that the rheological properties of the cement slurry with the weighting agent included are not adversely affected. In particular, the weighting agent should not increase the viscosity of the slurry beyond acceptable limits when present in the amount required to achieve the requisite density of the slurry. An increase in slurry viscosity in turn leads to an increase in the circulating density of the slurry when being used downhole, which in turn increases the hydrostatic pressure exerted by the slurry on the rock formation. In extreme cases, an excessive hydrostatic pressure can result in the rock formation being fractured, leading to a loss of the cement slurry into the formation itself. Such a loss of cement can compromise the zonal isolation and integrity of the wellbore. These, in turn, can result in problems with controlling the well, with attendant risks to safety and the environment. A loss of zonal isolation may require a remedial cementing operation to be conducted in the well, which is both costly and time consuming.

Further, the presence of the weighting agent should not adversely affect the stability of the cement slurry such that solid particles settle from the slurry and/or free water develops while the cement slurry is liquid. Such instability can compromise the cementing operation, leading to an imperfect cementing in the annular cavity around the casing. This in turn can lead to increases in the cost and complexity of any drilling and/or production operations.

As noted, weighting agents, methods for their preparation and their use are known in the art. Interestingly barite is not a commonly used weighting material for increasing the density of cement slurries. It has been reported by Fakhreldin, Y., “Durability of Portland Cement with and Without Metal Oxide Weighting Material in a CO2/H2S Environment”, SPE 149364-MS, 2012, page 2 and by Halliburton Company, “Halliburton Cementing Manual”, 2nd Edition, 1980, Heavy Weight Additives Section pages 1 to 2, that API grade barite is not recommended for use as a weighting agent because of the extra water required to wet the barite compared with other weighting agents. This lowers the compressive strength of the cement. In addition, the extra water dilutes the retarder concentration, affecting the expected setting time and shortening the pumping time available.

In the literature, methods of using barite in cement slurries have been proposed. U.S. Pat. No. 2,279,262 teaches the use of barite to make a weighted cement slurry. It is indicated that the particle size in the range of 20 mesh to 100 mesh (850 to 100 microns) gave the best performance. A similar disclosure is made in U.S. Pat. No. 2,526,674. However, this later document also notes the adverse settling possible with such coarse material and teaches the use of bentonite or other materials to form an emulsoid colloid (emulsion) which suspends the coarse barite.

U.S. Pat. No. 6,892,814 and U.S. Pat. No. 7,048,054 also relate to the use of a coarse barite, in which 90% of particles have a size greater than 125 microns. Both describe that the coarse barite is dry blended with a hydraulic cement, preferably a Portland cement prior to making the cement slurry. The benefit of using coarse barite is indicated to be the lower viscosity obtained compared to methods previously known in the art. This is due to a lower surface area needing to be wetted by the slurry water. Further, the coarse barite makes the mixing and pumping of the cement slurry easier than using conventional weighting. Both U.S. Pat. No. 6,892,814 and U.S. Pat. No. 7,048,054 make no indication that any improvement to the rate of settling can be obtained by following these teachings.

U.S. Pat. No. 7,169,738, discloses a method of using a sized barite as a weighting agent for drilling fluids. In one embodiment, the sized barite weighting agent has a particular diameter of from 4 to 15 microns. In another embodiment, the barite has a D₅₀ by weight of from 1 to 6 microns. The weighting agent is described as being of use in any wellbore fluid, such as drilling, cementation, completion, packing, work-over, stimulation, well killing and as a spacer fluid. Similar weighting agents and their uses are disclosed in US 2005/0277553, U.S. Pat. No. 7,176,165, U.S. Pat. No. 7,409,994, and U.S. Pat. No. 7,618,927. It should be noted that in none of these patents are there any examples of the use of the inventions described in cement slurries.

US 2009/0186781 discloses drilling fluids comprising sub-micron precipitated barite as a component of the weighting agent, together with method of using such drilling fluids in downhole operations. In particular, there is disclosed the use of a precipitated barite having a weight average particle diameter below about 1 micron and in particular, having a specific gravity of greater than about 2.6. Similar weighting agents and their uses are described in US 2009/019052 and US 2009/0258799. There is no indication of how barite may be used in forming cement slurries.

GB 2,315,505 is concerned with an additive for increasing the density of wellbore fluids. The additive is prepared by adding a dispersant to the particular weighting additive. Dispersants disclosed in GB 2,315,505 for use in an aqueous medium have water soluble polymers having a molecular weight of at least 2,000 Daltons, in particular homopolymers or copolymers of a monomer selected from acrylic acid, itaconic acid, maleic acid or anhydride, hydroxypropyl acrylate vinylsulphonic acid, acrylamido 2-propane sulphonic acid, acrylamide, styrene sulphonic acid, acrylic phosphate esters, methyl vinyl ether and vinyl acetate. Dispersing agents disclosed for use in organic media are carboxylic acids of molecular weight of at least 150, including oleic acid and polybasic fatty acids, alkylbenzene sulphonic acids, alkane sulphonic acids, linear alpha-olefin sulphonic acid or the alkaline earth metal salts thereof, phospholipids, such as lecithin, and synthetic polymers, such as Hypermer OM-1®. Similar disclosures of additive compositions for increasing the density of wellbore fluids are contained in U.S. Pat. No. 7,220,707, U.S. Pat. No. 7,267,291, and U.S. Pat. No. 7,589,049. It should be noted that in none of these patents are there any examples of the use of the inventions described in cement slurries, limiting the ability of one skilled in the art to follow the teachings as claimed.

An application of barite or similar weighting material as a gelling agent is described in U.S. Pat. No. 4,584,327. This document discloses an environmentally compatible high density drilling blow out fluid or cement composition which can provide densities between 24 and 40 ppg (2.876 and 4.793 s.g.). A gelling agent of particle size 0.5-10 microns is used to help suspend the weighting agent. The weighting agent may be selected from iron powder, hematite, other iron ores, steel shot, tungsten, tin, manganese, iron shot and mixtures thereof, which have a particle size 2 to 20 times the average particle size of the gelling agent. Barite is not listed as being a weighting agent, but rather is only indicated as being a gelling agent. Whilst this technique can overcome the loss of density found when following the teachings of U.S. Pat. No. 2,526,674, the density range indicated would not be achievable using barite alone, at least with not with the required pumpability or mixability. It is also to be noted that the examples given in U.S. Pat. No. 4,584,327 do not demonstrate the performance of the gelling agent and the weighting agent combination in a cement slurry. A similar disclosure is found in U.S. Pat. No. 4,519,922.

GB 1,541,759 describes a fluid for maintaining hydrostatic pressure comprising water, a viscosifier, an inhibitor, a water insoluble particulate solid weighting agent of 80% of particles between 2 to 20 microns and one or more dispersants, in particular one dispersant of a class of sulfonated naphthalene formaldehyde condensate, and a second dispersant being a fatty acid amide-sulfonated lignin liquor type. GB 1,541,759 discloses the use of sulfonated naphthalene formaldehyde condensate type dispersants for densities from 13.6 to 16 ppg (1.63 to 1.917 s.g.), with the addition of the fatty acid amide-sulfonated lignin liquor type dispersant to the fluid to enable dispersion of barite on its own or as a mixture with other weighting agents. It is apparent that the fluids disclosed would not be useable as part of the actual cement slurry and such use is not disclosed or suggested. Rather, the techniques disclosed can only be used as a completion fluid, packer fluid or ballast fluid as part of the cementing process, not the cement slurry.

A method of densifying cement slurries with barite is taught in U.S. Pat. No. 4,935,060. The barite is used as part of a composition including a fluid loss agent, a dispersant and silica sand or silica flour. U.S. Pat. No. 4,935,060 discloses the formulation of cement slurries with a density between 1.953-2.397 s.g. (16.3-20 ppg) and teaches how the use of silica sand and/or silica flour can overcome strength retrogression, have good pumpability and lower the tendency of settling to occur when using barite.

US 2010/044057A1 and US 2006/081372 describe fluids comprising vitrified shale or pumicite which are used to displace fluids in a wellbore. Such a displacement can occur during a cementing process and may involve a weighting agent such as barite. The fluids described are formulated to have compatibility with cement slurries, so that little effect on the properties of the cement occurs if a portion of the fluid is left in the wellbore. There is no disclosure of the use of barite in the cement slurries nor show how these fluids could be converted to useable cement compositions.

U.S. Pat. No. 6,908,508 describes a settable displacement fluid comprising vitrified shale and hydrated lime. The fluid may comprise barite. The fluid sets by reaction of hydrated lime, calcium silicate present in the vitrified shale and water. Whilst barite may be used as a weighting agent in a fluid which sets in a wellbore, the use of barite in a cement slurry is not disclosed.

It has now been found that an improved weighting agent may be provided by employing a finely divided high density solid weighting material coated by one or more specific sulphonic acids, their salts or derivatives as a dispersant.

Accordingly, in a first aspect, the present invention provides a weighting agent composition for use in a cement slurry for downhole operations in a subterranean well, the composition comprising:

a finely divided solid weighting agent; and

a dispersant comprising a sulphonic acid, salt or derivative thereof, the sulphonic acid having the general formula I:

-[A(OSOO⁻M⁺)-B-A′(OSOO⁻M⁺)]ₙ- (I)

wherein A and A′ are each an aromatic moiety;

B is an aliphatic moiety;

OSOO⁻M⁺ is a solubilising group consisting of sulphonic acid, a salt or derivative thereof; and

n is an integer of at least 2.

It has been found that the inclusion of a sulphonic acid derivative of general formula (I) recited above (hereafter generally referred to as the ‘dispersant’) in the weighting agent composition provides particular advantages over the known weighting agent compositions. In particular, it has been found that the compositions of the present invention readily disperse in a cement slurry without the need for additional dispersant components. In addition, the compositions of the present invention when dispersed in the cement slurry increase the viscosity of the slurry viscosity significantly less than known weighting agent compositions. Further, it has been found that the weighting agent composition of the present invention exhibits a reduced tendency for the particles to settle from the cement slurry and a reduced tendency to produce free water compared with known compositions.

The composition of the present invention comprises a finely divided solid weighting agent. The weighting agent may be any high density solid that is suitable for inclusion in a cement slurry for use in downhole operations. Such solid weighting agents are known in the art. Suitable weighting agents for inclusion in the composition of the present invention include salts of one or more metals. Examples of metal salts are salts of Group II metals, such as calcium, strontium and barium, and transition metals, such as manganese, iron and titanium. Examples of the metal salts for inclusion in the composition include oxides, sulphites, sulphates and carbonates.

Particular examples of weighting agents that are preferred for inclusion in the composition of the present invention are barites, ilmenites, strontium carbonate and hematite. Salts of barium are particularly suitable for use as the weighting agent in the compositions of the present invention, with barites being especially preferred.

The weighting agent is present in the weighting agent composition in a finely divided form. Methods for preparing finely divided weighting agents are known in the art and are discussed in more detail hereinafter. The weighting agent should have a particle size of sufficient fineness such that the particles have a significantly reduced tendency to settle in a cement slurry. Typically, the finely divided weighting agent will have a range of particle sizes, the particular particle size distribution depending upon such factors as the method used to prepare the material. Preferably, the finely divided weighting agent has a particle size distribution such that at least 50% by weight of the particles have an equivalent spherical diameter (D₅₀) of less than 5 microns. More preferably between 5 and 3 microns, more preferably less than 3 microns, still more preferably less than 2 microns. It is particularly preferred that the finely divided weighting agent has a D₅₀ of less than 1 micron. In one preferred embodiment, the finely divided weighting agent has a D₅₀ of 0.5 micron or less.

It is particularly preferred that the finely divided weighting agent has a particle size distribution such that at least 30% by weight of the particles has a diameter less than 2 micron, in particular at least 50% by weight, more preferably at least 60% by weight, still more preferably at least 70% by weight. The finely divided weighting agent may have a particle size distribution such that at least 95% by weight of the particles has a diameter less than 2 micron. In this respect, references to the diameter of the particles are again references to the equivalent spherical diameter.

The particle size distribution of the finely divided weighting agent may be determined using techniques known in the art, for example using commercially available equipment, such as a Malvern Mastersizer-Microplus laser sizing system using a dilute aqueous dispersion of the finely divided weighting agent.

The composition further comprises the dispersant. The dispersant employed in the present invention is a soluble salt, derivative or free sulphonic acid having the general formula I:

-[A(OSOO⁻M⁺)-B-A′(OSOO⁻M⁺)]ₙ- (I)

The dispersant molecules may be generally characterised as being salts, derivatives or free acids of sulphonic acids consisting of aromatic moieties (A and A′) with a sulphonic acid solubilising group, connected to an aliphatic moiety (B).

In the compounds of formula I, A and A′ are both aromatic moieties. The aromatic moieties of A and A′ may be the same or different. The aromatic moieties of A and A′ may consist of carbon atoms or comprise one or more other species, in particular one or more nitrogen, sulphur or oxygen atoms. Examples of suitable aromatic moieties include phenol, naphthalene, anthracene, phenanthrene, melamine, pyridine, pyrazine, imidazole, pyrazole, oxazole, thiophene, isomers thereof, where appropriate, and their benzannulated derivatives. Naphthalene and melamine are two particularly preferred aromatic moieties for A and/or A′.

In the compounds of general formula I, B is an aliphatic moiety, preferably a saturated aliphatic moiety. Preferably, B is an alkyl group comprising one or more carbon atoms. The alkyl group may be straight chain or branched. The alkyl group preferably has from 1 to 20, more preferably from 1 to 12, still more preferably from 1 to 8 carbon atoms. Especially preferred are compounds in which B is an alkyl group having from 1 to 4 carbon atoms. The compounds of general formula I may be prepared from aldehydes to provide the aliphatic moiety B, in particular monoaldehydes, such as formaldehyde, acetaldehyde and propionaldehyde, and dialdehydes, such as glyoxal.

The moiety OSOO⁻M⁺ in the compounds of general formula I is a solubilising group consisting of sulphonic acid as the free acid, salt or derivatives thereof, with M being hydrogen, in the case of the free acid, or a cation, in the case of the compound being a salt. Salts are particularly preferred. The salt may contain any suitable cation. The salt is preferably a metal salt, in particular an alkali metal or alkaline earth metal salt, with alkali metal salts, such as the sodium and potassium salts, being especially preferred.

Alternatively, derivatives of the aforementioned compounds may be used, for example esters thereof, in which the group OSOO⁻M⁺ is a group of formula OSOOR, wherein R is an aromatic or an aliphatic moiety. Suitable aromatic moieties are as hereinbefore described. Suitable aliphatic moieties include alkyl groups, in particular alkyl groups having from 1 to 12, more preferably from 1 to 8, still more preferably from 1 to 6 carbon atoms. Further derivatives that may be used as the dispersant include sulfonyl halides, that is compounds in which the group OSOO⁻M⁺ is replaced by a group OSOOM′, in which M′ is a halogen, in particular chlorine or bromine.

Compounds of general formula I in the form of salts, in particular alkali metal salts, are particularly preferred for use as dispersants in the present invention.

The compounds of general formula I comprise n repeating units, where n is an integer. The compounds comprise two or more repeating units, preferably with n being from 2 to 30, in particular from 2 to 20, more preferably from 2 to 15, still more preferably from 2 to 10.

Two examples of preferred compounds of general formula I for use as dispersants in the present invention are sulphonated polycyclic aromatic hydrocarbon-acetaldehyde condensate polymers and sulphonated melamine acetaldehyde condensate polymers, especially sulphonated naphthalene formaldehyde condensate polymers and sulphonated melamine formaldehyde condensate polymers. Such dispersants have been found to be particularly suitable for combination with barites to provide the composition of the present invention.

Compounds of the general formula I are known in the art and are commercially available, or may be prepared using synthesis routes known in the art.

The dispersant may be present in any suitable amount, provided that it imparts the weighting agent composition with the appropriate properties. In particular, the dispersant may be present in an amount of up to 5% by weight of the finely divided weighting agent, more preferably up to 3% by weight, still more preferably up to 2% by weight of the finely divided weighting agent. The dispersant is preferably present in an amount of at least 0.1% by weight of the finely divided weighting agent, more preferably at least 0.5% by weight, still more preferably at least 1% by weight of the weighting agent.

The composition may be provided as a dry composition. The dry composition preferably has a moisture content of less than 2% by weight, more preferably less than 1% by weight. In the dry composition, the dispersant is present as a coating on the particles of the finely divided weighting agent.

Alternatively, the composition may be provided as a slurry of the weighting agent in a suitable liquid. Most preferably, if provided as a slurry, the composition is a slurry of the weighting agent in water, that is an aqueous slurry. The slurry may have a solids content in any suitable range for combining with a cement slurry. Typically, the weighting agent slurry composition has a solids content of at least 30% by weight, preferably at least 40% by weight, still more preferably at least 50% by weight, especially at least 60% by weight.

In a further aspect, the present invention provides a method for preparing a weighting agent composition for use in a cement slurry for downhole operations in a subterranean well, the method comprising:

preparing a finely divided solid weighting agent; and

coating the solid weighting agent with a dispersant as hereinbefore defined.

The dispersant may be combined with the weighting agent during its preparation, as described in more detail hereinafter. Alternatively, or in addition the dispersant may be combined with the finely divided weighting agent once prepared. As set out below, it has been found advantageous to combine at least a portion of the dispersant required in the final composition with the weighting agent while being finely divided.

The finely divided weighting agent may be prepared from a weighting agent starting material using any suitable technique. Such techniques are known in the art and include grinding or milling. Such techniques are disclosed, for example in GB 1,472,701 and GB 1,599,632, which both describe method for grinding a substrate to form a finely divided solid material. Other techniques for forming the finely divided weighting agent include precipitation.

The finely divided weighting agent is preferably prepared by milling. The milling may be a dry milling technique. More preferably, the finely divided weighting agent is prepared by a wet milling process, that is the weighting agent is milled in the presence of a suitable grinding agent and a liquid. Suitable liquids for use in wet milling are known in the art and include various oils or other organic liquids. Preferably, the wet milling is conducted using water.

The weighting agent may be milled using any suitable grinding, such as in a ball milling or sand grinding operation.

As noted above, while the dispersant can be combined with the finely divided weighting agent once prepared, it is preferred to combine the dispersant with the weighting agent during its preparation. It has been found that the dispersant is advantageously combined with the weighting agent during the milling procedure. The dispersant, when present during the milling operation, improves the properties of the finely divided weighting agent produced.

It has also been found that the dispersant may be used in the milling procedure with the weighting agent in higher concentrations, in turn improving the efficiency of the process. In particular, it has been found that when the dispersants of the present invention are used in the milling procedure, the viscosity of the slurry being milled is significantly reduce, in turn allowing the solids content of the slurry during the milling operation to be increased. In particular, the dispersants of the present invention are effective to allow milling of the weighting agent in a slurry with a solids content above 50% by weight and up to 85% by weight. In this way, the efficiency of the milling operation is increased. Further, the reduced liquid content required during the milling operation reduces the volume of liquid required to be removed in any subsequent drying operation.

When present with the weighting agent during the milling or grinding operation, the dispersant may be present in any suitable amount that is sufficient to provide the required functions in the cement slurry. In particular, the dispersant may be present in an amount of up to 5% by weight of the finely divided weighting agent, more preferably up to 3% by weight, still more preferably up to 2% by weight of the finely divided weighting agent. The dispersant is preferably present in an amount of at least 0.1% by weight of the finely divided weighting agent, more preferably at least 0.5% by weight, still more preferably at least 1% by weight of the weighting agent.

The finely divided weighting agent is produced in the milling operation with a coating of the dispersant thereon. Once the milling operation is completed, the finely divided coated weighting agent is separated from the grinding agent in a known manner, for example by sieving.

The finely divided weighting agent may be retained as a slurry, with liquid in particular water, in the preferred embodiments, being added or removed, to provide the slurry with the required solids content.

Alternatively, the finely divided weighting agent may be dried. Any suitable drying technique may be employed. Such techniques are known in the art and include spray drying, drum drying and vacuum drying. If the finely divided weighting agent is to be provided as a dried product, spray drying is the preferred technique. It has been found that the weighting agent composition, when prepared by spray drying, is a free-flowing product that is easily conveyed, transported, stored and used. Further, it has been found that the coating of the finely divided weighting agent with the dispersant advantageously allows the spray dried product to be recombined with water and readily dispersed to provide a slurry with substantially the same particle size distribution as the ground slurry immediately before spray drying.

It is particularly preferred that the composition is provided in a dry form, in particular a dry, free-flowing material.

As described above, it has been found that the dispersant is advantageously present during the preparation of the finely divided weighting agent by milling or grinding.

Accordingly, in a further aspect, the present invention provides a method of preparing a finely divided weighting agent, the method comprising milling a weighting agent starting material in the presence of a dispersant.

Details of the milling procedure are as set out hereinbefore.

As described above, the weighting agent composition of the present invention finds particular use as a weighting agent for a cement slurry used in a downhole cementing operation in a subterranean well.

Accordingly, in a still further aspect, the present invention provides a cement slurry comprising a weighting agent composition as hereinbefore described.

The weighting agent composition is included in the cement slurry to provide the necessary increased density and specific gravity to the cement slurry for effective use in the downhole cementing operation. Accordingly, the amount of weighting agent composition to be included in the cement slurry will be determined by the conditions of the cementing operation, including the factors described above, such as the depth of the well or the portion of the well to be cemented and the pressure of any fluids retained in the rock formation in which the well is formed. Typically, the weighting agent composition is added in an amount of up to 60% by weight.

Still further, the present invention provides the use of a composition as hereinbefore defined for a weighting agent for a cement slurry.

In a further aspect, the present invention provides the use of a composition as hereinbefore defined in a downhole cementing operation.

Finally, there is provided by the present invention a method of cementing a subterranean well, comprising providing in the well, in particular to an annulus between a casing and the rock formation in which the well is formed, a cement slurry comprising a weighting agent composition as hereinbefore described.

Embodiments of the present invention will now be described for illustrative purposes only by way of the following examples, having reference to the following figures:

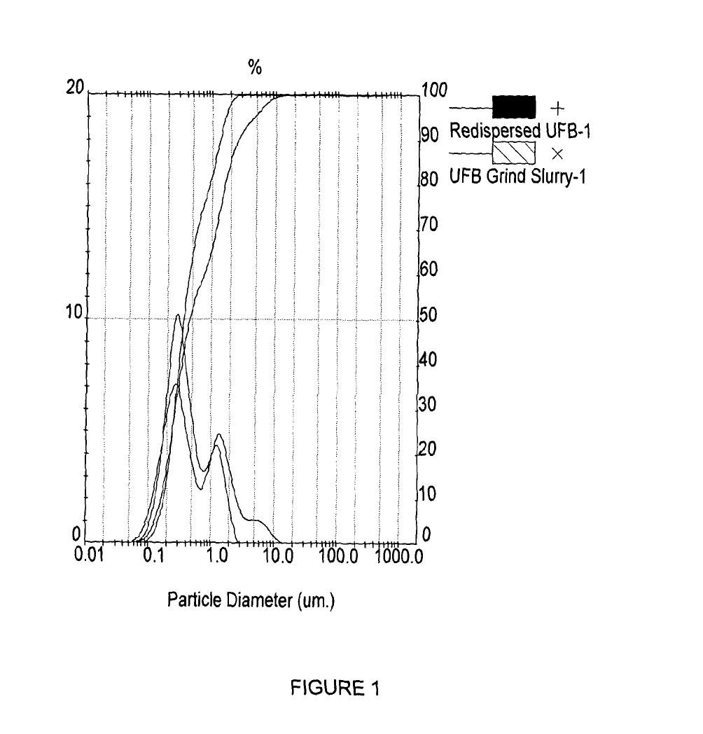

FIG. 1 is a graph of the particle size distribution of a weighting agent composition of one embodiment of the present invention.

### EXAMPLE 1

A slurry of a finely divided weighting agent was prepared in the following manner:

A slurry of a barite weighting agent starting material (70% by weight of the slurry), the sodium salt of a sulphonated naphthalene-formaldehyde condensate polymer ((C₁₁H₇O₄SNa)ₙ) (2% by weight of the barite) and water was provided in a sand grinding mill with sand as a grinding agent. The pH of the slurry was adjusted to 10 by the addition of sodium hydroxide. The mill was operated at a power input of from 75 to 150 kWh/t to produce a slurry of finely divided barite.

The sand was removed by screening, to produce an aqueous slurry of finely divided barite.

A sample of the slurry was removed and diluted with deionised water. The particle size distribution of the resulting sample was determined using a Malvern Mastersizer-Microplus laser particle sizer. The particle size distribution of the finely divided barite is shown in FIG. 1. As can be seen, at least 75% by weight of the barite particles had an equivalent spherical diameter of less than 2 microns.

The aqueous slurry of finely divided barite was spray dried using a commercially available spray drying system. This product is hereinafter designated as Product A.

### EXAMPLE 2

A sample of Product A was dispersed in water using a commercially available mixer (Heidolph RZR 2041) running at 1000 rpm. The particle size distribution of the solid material in the resulting dispersion was determined using the apparatus and method described. The particle size distribution of the redispersed finely divided barite is also shown in FIG. 1.

As can be seen from FIG. 1, Product A was capable of being redispersed after spray drying to provide a slurry having a particle size distribution substantially the same as that of the wet product recovered from the milling procedure and before spray drying. This demonstrates that Product A would readily disperse in a cement slurry, with no significant change in the particle size distribution of the finely divided barite material.

### EXAMPLE 3

For comparative purposes, a weighting agent composition was prepared using the general teaching of GB 2,315,505. In particular, a weighting agent composition was prepared using the same method as set out in Example 1 above, but with the sodium salt of a sulphonated naphthalene-formaldehyde condensate polymer replaced by a mixture of salts of acrylate and 2-acrylamido-2-methylpropane sulfonic acid polymers as the dispersant, consistent with the teaching of GB 2,315,505. This product is hereinafter designated as Comparison A.

The particle size distribution of the finely divided barite material in Comparison A was determined using the method set out in Example 1 and found to be substantially the same as that for Product A.

### EXAMPLE 4

The properties of Product A prepared in Example 1 when incorporated in a cement slurry were tested as set out below. The properties of the Comparison A product were tested in like manner and compared with those of Product A.

A cement slurry was prepared by mixing LeHigh Class H cement (94 lbs (42.63 Kg)) with deionised water (4.36 gallons (36.38 L)) until the cement was homogenously dispersed in the slurry. Product A was added in an amount of 30% by weight of cement to the slurry, with further mixing until a homogeneous dispersion was obtained. It was noted that the Product A dispersed evenly in the cement slurry. The resulting cement slurry had a density of 18.07 pounds per gallon and a specific gravity of 2.167. The resulting cement slurry is hereinafter designated as Cement Slurry A.

A cement slurry comprising Comparison A was prepared in identical manner with corresponding amounts of cement, water and Comparison A as weighting agent. The resulting cement slurry had a density of 18.13 pounds per gallon and a specific gravity of 2.173. The resulting cement slurry is hereinafter designated as Comparison Slurry A.

The rheological properties of Cement Slurry A and Comparison Slurry A were measured using a Chandler Chan 35 viscometer at temperatures of 80° F. (27° C.) and 130° F. (54° C.). The results are summarised in Table 1.

TABLE 1

| | Cement Slurry A | | Comparison Slurry A | |
|---|---|---|---|---|
| | Temperature | | | |
| | 80° F. | 130° F. | 80° F. | 130° F. |
| Viscometer | (27° C.) | (54° C.) | (27° C.) | (54° C.) |
| Rotation | Viscosity (cP | Viscosity (cP | Viscosity (cP | Viscosity (cP |
| Speed (rpm) | (Pa S)) | (Pa S)) | (Pa S)) | (Pa S)) |
| 300 | 77 (0.077) | 130 (0.130) | 255 (0.255) | 245 (0.245) |
| 200 | 67 (0.067) | 122 (0.122) | 229 (0.229) | 225 (0.225 |
| 100 | 56 (0.056) | 107 (0.107) | 198 (0.198) | 187 (0.187) |
| 60 | 48 (0.048) | 104 (0.104) | 179 (0.179) | 169 (0.169) |
| 30 | 38 (0.038) | 89 (0.089) | 132 (0.132) | 131 (0.131) |
| 6 | 32 (0.032) | 70 (0.070) | 64 (0.064) | 56 (0.056) |
| 3 | 31 (0.031) | 52 (0.052) | 46 (0.046) | 45 (0.045) |
| Plastic | 32 (0.032) | 35 (0.035) | 86 (0.086) | 87 (0.087) |
| Viscosity | | | | |
| (cP) | | | | |
| Yield Point | 46 (0.046) | 96 (0.096) | 170 (0.170) | 158 (0.158) |
| (pounds/100 | | | | |
| ft² (Pa)) | | | | |

As can be seen in Table 1, the cement slurry comprising Product A according to the present invention exhibited a significantly lower plastic viscosity and yield point that the cement slurry prepared using Comparison Product A. In practice, Cement Slurry A comprising the weighting agent composition of the present invention will exhibit a significantly lower equivalent circulating density when the cement slurry is pumped, for example when pumped downhole, compared with Comparison Slurry A. This in turn will reduce the induced lost circulation that could arise with Cement Slurry A, compared with that of Comparison Slurry A.

The setting times and the set strength of Cement Slurry A and Comparison Slurry A were both determined using an ultrasonic cement analyser. In particular, the time for each cement slurry to set to a compressive strength of 50 psi (345 kPa) and 500 psi (3447 kPa) was measured. Further, the compressive strength in psi (kPa in brackets) was determined after both 12 hours and 24 hours of setting. The results are set out in Table 2.

TABLE 2

| | Cement Slurry A | Comparison Slurry A |
|---|---|---|
| Time to 50 psi | 3:25 | 4:22 |
| (345 kPa) (hr:min) | | |
| Time to 500 psi | 4:42 | 5:42 |
| (3447 kPa) (hr:min) | | |
| Compressive strength at | 1731 (11935) | 1528 (10535) |
| 12 hours (psi (kPa)) | | |
| Compressive strength at | 2591 (17864) | 2350 (16203) |
| 24 hours (psi (kPa)) | | |

As can be seen from the data in Table 2, the setting of Cement Slurry A is less retarded than that of Comparison Slurry A. Further, the set strength at both 12 hours and 24 hours was significantly higher for Cement Slurry A comprising the weighting agent composition of the present invention.

### EXAMPLE 5

For comparison purposes, two further cement slurries were prepared using API barite as a weighting agent. The method and quantities of components as set out in Example 4 were followed in each case. Comparison Slurry B consisted of LeHigh Class H cement, water and API barite in the amounts set out in Example 4. Comparison Slurry C comprised the same components in the same amounts, with the addition of 0.4% of a commercially available cement dispersant.

The rheological properties of Comparison Slurry B and Comparison Slurry C were measured using a Chandler Chan 35 viscometer at temperatures of 80° F. (27° C.) and 130° F. (54° C.). The results are summarised in Table 3.

TABLE 3

| | Comparison Slurry B | | Comparison Slurry C | |
|---|---|---|---|---|
| | Temperature | | | |
| | 80° F. | 130° F. | 80° F. | 130° F. |
| Viscometer | (27° C.) | (54° C.) | (27° C.) | (54° C.) |
| Rotation | Viscosity (cP | Viscosity (cP | Viscosity (cP | Viscosity (cP |
| Speed (rpm) | (Pa S)) | (Pa S)) | (Pa S)) | (Pa S)) |
| 300 | 194 (0.194) | 268 (0.268) | 62 (0.062) | 106 (0.106) |
| 200 | 163 (0.163) | 237 (0.237) | 48 (0.048) | 102 (0.102) |
| 100 | 128 (0.128) | 201 (0.201) | 46 (0.046) | 94 (0.094) |
| 60 | 110 (0.110) | 166 (0.166) | 30 (0.030) | 90 (0.090) |
| 30 | 85 (0.085) | 127 (0.127) | 28 (0.028) | 74 (0.074) |
| 6 | 44 (0.044) | 82 (0.082) | 14 (0.014) | 18 (0.018) |
| 3 | 30 (0.030) | 62 (0.062) | 10 (0.010) | 18 (0.018) |
| Plastic | 99 (0.099) | 101 (0.101) | 24 (0.024) | 18 (0.018) |
| Viscosity | | | | |
| (cP (Pa S)) | | | | |
| Yield Point | 95 (0.095) | 168 (0.168) | 38 (0.038) | 88 (0.088) |
| (pounds/100 | | | | |
| ft² (Pa) | | | | |

As indicated by the data in Table 3, Comparison Slurry B had a very high viscosity that rendered it unacceptable in well cementing applications. The inclusion of the dispersant in Comparison Slurry C improved the rheological properties and reduced the viscosity to acceptable levels for use in a well cementing operation. However, comparison with the data in Table 1 shows that a significant amount of dispersant is required in addition to the weighting agent in Comparison Slurry C in order to provide acceptable rheological properties comparable with Cement Slurry A of the present invention. Thus, operators at the well head would be required to add the dispersant to the required level during the cementing operation in order to achieve acceptable rheology. This additional step in the formulation of the weighted cement slurry is not required with Cement Slurry A of the present invention.

No further testing was carried out on Comparison Slurry B. The stability of Cement Slurry A of the present invention and Comparison Slurry C was determined using a free water test, in which the formation of a layer of free water was observed. No free water was observed when Cement Slurry A was allowed to stand. In contrast, Comparison Slurry C exhibited a free water formation of 1.6% due to solids settling in the slurry when allowed to stand.

The setting times and the set strength of Comparison Slurry C were determined using an ultrasonic cement analyser. In particular, the time for the cement slurry to set to a compressive strength of 50 psi (345 kPa) and 500 psi (3447 kPa) was measured. Further, the compressive strength in psi was determined after both 12 hours and 24 hours of setting. The results are set out in Table 4.

TABLE 4

| | Comparison Slurry C |
|---|---|
| Time to 50 psi | 3:13 |
| (345 kPa) (hr:min) | |
| Time to 500 psi | 4:42 |
| (3447 kPa) (hr:min) | |
| Compressive strength at | 1917 (13217) |
| 12 hours (psi (kPa)) | |
| Compressive strength at | 2917 (20112) |
| 24 hours (psi(kPa)) | |

As can be seen from the data in Table 4, the setting of Comparison Slurry C is comparable with that of Cement Slurry A of the present invention. To further compare the cement formulations, each set cement core was subject to a static settling test. The cement cores were divided into three equal portions: a top portion; a mid portion; and a bottom portion. The density of each portion was measured and the variance of each cement determined to establish the consistency of the density of the cement core throughout its depth. The results are set out in Table 5.

TABLE 5

| | Cement Slurry A | Comparison Slurry C |
|---|---|---|
| Top Portion Density | 18.3 (2.196) | 18.6 (2.232) |
| (pounds/gallon (s.g.)) | | |
| Mid Portion Density | 18.5 (2.220) | 18.8 (2.256) |
| (pounds/gallon (s.g.)) | | |
| Bottom Portion Density | 18.6 (2.232) | 19.2 (2.305) |
| (pounds/gallon (s.g.)) | | |
| Variance (%) | 1.61 | 3.14 |

As can be seen from the data in Table 5, the cement core prepared using Cement Slurry A exhibited a significantly more consistent density throughout the core than the core prepared using Comparison Slurry C.

### EXAMPLE 6

A further cement slurry according to the present invention was prepared as set out in Example 4. In particular, a cement slurry was prepared by mixing LeHigh Class H cement (94 lbs (42.36 Kg)) with deionised water (4.36 gallons (36.38 L)) until the cement was homogenously dispersed in the slurry. Product A was added in an amount of 39.6% by weight of cement to the slurry, with further mixing until a homogeneous dispersion was obtained. It was noted that the Product A dispersed evenly in the cement slurry. A commercially available cement retarder (0.2% by weight) was also included in the slurry composition. The resulting cement slurry had a density of 18.5 pounds per gallon and a specific gravity of 2.218. The resulting cement slurry is hereinafter designated as Cement Slurry B.

For comparison purposes, a further cement slurry was prepared using finely divided hematite as a weighting agent. Hematite is a weighting agent commonly applied in well cementing operations. The method and quantities of components as set out in Example 4 were followed. A cement slurry was prepared by mixing LeHigh Class H cement (94 lbs (42.36 Kg)) with deionised water (4.36 gallons (36.38 L)) until the cement was homogenously dispersed in the slurry. Hematite was added in an amount of 32.9% by weight of cement to the slurry, with further mixing until a homogeneous dispersion was obtained. A commercially available cement retarder (0.2% by weight) and a commercially available dispersant (0.3% by weight) were also included in the slurry composition. The resulting cement slurry had a density of 18.5 pounds per gallon and a specific gravity of 2.218. The resulting cement slurry is hereinafter designated as Comparison Slurry D.

The rheological properties of Cement Slurry B and Comparison Slurry D were measured using a Chandler Chan 35 viscometer at temperatures of 80° F. (27° C.) and 190° F. (54° C.). The results are summarised in Table 6.

TABLE 6

| | Product Slurry B | | Comparison Slurry D | |
|---|---|---|---|---|
| | Temperature | | | |
| | 80° F. | 190° F. | 80° F. | 190° F. |
| Viscometer | (27° C.) | (88° C.) | (27° C.) | (88° C.) |
| Rotation | Viscosity (cP | Viscosity (cP | Viscosity (cP | Viscosity (cP |
| Speed (rpm) | (Pa s)) | (Pa s)) | (Pa s)) | (Pa s)) |
| 300 | 64 (0.064) | 66 (0.066) | 86 (0.086) | 26 (0.026) |
| 200 | 50 (0.050) | 56 (0.056) | 64 (0.064) | 20 (0.020) |
| 100 | 34 (0.034) | 45 (0.045) | 38 (0.038) | 13 (0.013) |
| 60 | 27 (0.027) | 40 (0.040) | 24 (0.024) | 11 (0.011) |
| 30 | 21 (0.021) | 36 (0.036) | 15 (0.015) | 9 (0.009) |
| 6 | 15 (0.015) | 26 (0.026) | 9 (0.009) | 7 (0.007) |
| 3 | 12 (0.012) | 20 (0.020) | 7 (0.007) | 5 (0.005) |
| Plastic | 45 (0.045) | 32 (0.032) | 72 (0.072) | 20 (0.020) |
| Viscosity | | | | |
| (cP (Pa s)) | | | | |
| Yield Point | 19 (0.019) | 35 (0.035) | 14 (0.014) | 7 (0.007) |
| (pounds/100 | | | | |
| ft² (Pa)) | | | | |

As can be seen from the data set out in Table 6, Comparison Slurry D exhibited a low yield point, in particular at 190° F. (88° C.), indicating that the cement slurry would be more susceptible to the weighting agent settling from the slurry, compared with Comparison Slurry B of the present invention.

The stability of Cement Slurry B of the present invention and Comparison Slurry D was determined using a free water test, in which the formation of a layer of free water was observed. No free water was observed when Cement Slurry B was allowed to stand. In contrast, Comparison Slurry D exhibited a free water formation of 0.4% due to solids settling in the slurry when allowed to stand.

The setting times and the set strengths of Cement Slurry B and Comparison Slurry D were determined using an ultrasonic cement analyser. In particular, the time for the cement slurry to set to a compressive strength of 50 psi (345 kPa) and 500 psi (3447 kPa) was measured. Further, the compressive strength in psi was determined after both 12 hours and 24 hours of setting. The results are set out in Table 7.

TABLE 7

| | Cement Slurry B | Comparison Slurry D |
|---|---|---|
| Time to 50 psi | 4:14 | 4:09 |
| (345 kPa) (hr:min) | | |
| Time to 500 psi | 4:35 | 4:35 |
| (3447 kPa)(hr:min) | | |
| Compressive strength at | 2375 (16375) | 3477 (23975) |
| 12 hours (psi (kPa)) | | |
| Compressive strength at | 3507 (24180) | 4741 (32688) |
| 24 hours (psi (kPa)) | | |

As can be seen from the data in Table 7, the setting of Comparison Slurry D is comparable with that of Cement Slurry B of the present invention. To further compare the cement formulations, each set cement core was subject to a static settling test. The cement cores were divided into three equal portions: a top portion; a mid portion; and a bottom portion. The density of each portion was measured and the variance of each cement determined to establish the consistency of the density of the cement core throughout its depth. The results are set out in Table 8.

TABLE 8

| | Cement Slurry B | Comparison Slurry D |
|---|---|---|
| Top Portion Density | 18.8 (2.257) | 19.1 (2.293) |
| (pounds/gallon, (s.g.)) | | |
| Mid Portion Density | 18.9 (2.269) | 19.6 (2.353) |
| (pounds/gallon, (s.g.)) | | |
| Bottom Portion Density | 19.0 (2.281) | 19.8 (2.377) |
| (pounds/gallon, (s.g.)) | | |
| Variance (%) | 1.05 | 3.54 |

As can be seen from the data in Table 8, the cement core prepared using Cement Slurry B exhibited a significantly more consistent density throughout the core than the core prepared using Comparison Slurry D.

### EXAMPLE 7

Two coated finely divided barite samples were prepared according to the present invention, following the general procedure outlined in Example 1.

To prepare the first barite sample (hereafter ‘Barite 1’) barite was finely ground to give a D₅₀ in the range of from 2 to 3 microns. To prepare the second barite sample (hereafter ‘Barite 2’), barite was ground to give a D₅₀ in the range of from 3 to 5 microns. Both barite samples were ground in the presence of a sulfonated naphthalene formaldehyde condensate dispersant at a loading of 2% by weight of barite using a sand grinding procedure and then spray dried to give a dry free flowing powder in a similar manner as described in Example 1.

17.5 ppg (2.097 s.g.) and 19 ppg (2.277 s.g.) cement slurries (Slurries E and F and Slurries I and J) were formulated as set out in Tables 9 and 10 below, according to the present invention.

For comparison purposes, similar slurries were prepared using hematite and Micromax FF™ (A trade name of a manganese trioxide based product from Elkem of Oslo, Norway). Details of these comparison slurries are also set out in Tables 9 and 10 below.

Slurries E, F, I and J contained the barites manufactured according to the present invention, slurries G and K contained hematite and slurries H and L contained Micromax FF™.

TABLE 9
17.5 ppg (2.097 s.g.), 200° F.

| | | | | | | Slurry H |
|---|---|---|---|---|---|---|
| Com- | | | Slurry E | Slurry F | Slurry G | Micromax |
| ponent | Function | Units | Barite 1 | Barite 2 | Hematite | FF |
| Kelig | Retarder | % bwoc | 0.2 | 0.2 | 0.2 | 0.2 |
| 32 | | | | | | |
| C-41P | Antifoam | % bwoc | 0.2 | 0.2 | 0.2 | 0.2 |
| Varies | Weighting | % bwoc | 5.1 | 5 | 4.3 | 4.45 |
| | agent | | | | | |
| FL-24 | Fluid Loss | % bwoc | 0.3 | 0.3 | 0.3 | 0.3 |
| | agent | | | | | |
| Le High | Cement | lbs/sk | 94 | 94 | 94 | 94 |
| class H | | (Kg) | (42.64) | (42.64) | (42.64) | (42.64) |
| Water | | gal/sk | 3.62 | 3.62 | 3.62 | 3.62 |
| | | (L) | (13.70) | (13.70) | (13.70) | (13.70) |

% bwoc = Percentage by weight of cement;
lbs/sk = pounds per sack;
gal/sk = gallons (US) per sack.

TABLE 10
19 ppg (2.277 s.g.), 200° F.

| | | | | | | Slurry L |
|---|---|---|---|---|---|---|
| Com- | | | Slurry I | Slurry J | Slurry K | Micromax |
| ponent | Function | Units | Barite 1 | Barite 2 | Hematite | FF |
| Kelig | Retarder | % bwoc | 0.2 | 0.2 | 0.2 | 0.2 |
| 32 | | | | | | |
| C-41P | Antifoam | % bwoc | 0.2 | 0.2 | 0.2 | 0.2 |
| Varies | Weighting | % bwoc | 50.2 | 49.2 | 41.5 | 43.2 |
| | Agent | | | | | |
| FL-24 | Fluid Loss | % bwoc | 0.3 | 0.3 | 0.3 | 0.3 |
| | agent | | | | | |
| Le High | Cement | lbs/sk | 94 | 94 | 94 | 94 |
| Class H | | (Kg) | (42.64) | (42.64) | (42.64) | (42.64) |
| Water | | gal/sk | 4.37 | 4.37 | 4.37 | 4.37 |
| | | (L) | (16.54) | (16.54) | (16.54) | (16.54) |

The performance of the slurries was tested in a similar manner to that described in the previous examples. The results are presented below in Table 11 for the 17.5 ppg (2.097 s.g.) cement slurries and Table 12 for the 19 ppg (2.277 s.g.) cement slurries

TABLE 11
17.5 ppg (2.097 s.g.) 200° F. (93° C.)

| | Slurry E | | | | Slurry F | | | | Slurry G | | | | Slurry H | | | |
|---|---|---|---|---|---|---|---|---|---|---|---|---|---|---|---|---|
| Thickening | 04:24 | | | | 04:54 | | | | 03:46 | | | | 06:03 | | | |
| Time | | | | | | | | | | | | | | | | |
| (hour:minutes) | | | | | | | | | | | | | | | | |
| Free Water | Trace | | | | 0 | | | | 0 | | | | 0 | | | |
| Rheology | 80 | (27) | 190 | (88) | 80 | (27) | 190 | (88) | 80 | (27) | 190 | (88) | 80 | (27) | 190 | (88) |
| Measurement | | | | | | | | | | | | | | | | |
| Temperature | | | | | | | | | | | | | | | | |
| ° F., (° C.) | | | | | | | | | | | | | | | | |
| Plastic | 244 | (0.244) | 226 | (0.226) | 258 | (0.258) | 232 | (0.232) | 305 | (0.305) | 243 | (0.243) | 247 | (0.247) | 214 | (0.214) |
| Viscosity (cP | | | | | | | | | | | | | | | | |
| (Pa s)) | | | | | | | | | | | | | | | | |
| Yield Point | 33 | (0.033) | 85 | (0.085) | 39 | (0.039) | 129 | (0.129) | 49 | (0.049) | 68 | (0.068) | 38 | (0.038) | 170 | (0.170) |
| (pounds/100 ft² | | | | | | | | | | | | | | | | |
| (Pa)) | | | | | | | | | | | | | | | | |

| | | | | |
|---|---|---|---|---|
| UCA time to | 02:26 | 03:04 | 02:24 | 03:17 |
| 50 psi | | | | |
| (345 Kpa) | | | | |
| Compressive | 4733 (32634) | 2776 (19141) | 3512 (24215) | 1062 (7322) |
| Strength at 12 | | | | |
| hours Psi | | | | |
| (KPa) | | | | |
| Static settling | 1.90% | 0.33% | 2.60% | |
| variance | | | | |
| Dynamic | 0.23% | 0.05% | 0.73% | 0.40% |
| settling | | | | |
| variance | | | | |
| Time to mix in | 23 | 13 | 32 | 10 |
| dry weighting | | | | |
| agent and | | | | |
| achieve vortex | | | | |
| Low speed | | | | |
| (seconds) | | | | |

TABLE 12
19 ppg (2.277 s.g.) 200° F. (93° C.)

| | Slurry I | | | | Slurry J | | | | Slurry K | | | | Slurry L | | | |
|---|---|---|---|---|---|---|---|---|---|---|---|---|---|---|---|---|
| Thickening | 07:44 | | | | 07:39 | | | | 03:46 | | | | 06:37 | | | |
| Time | | | | | | | | | | | | | | | | |
| (hour:minutes) | | | | | | | | | | | | | | | | |
| Free Water | Trace | | | | Trace | | | | 0 | | | | 0 | | | |
| Rheology | 80 | (27) | 190 | (88) | 80 | (27) | 190 | (88) | 80 | (27) | 190 | (88) | 80 | (27) | 190 | (88) |
| Measurement | | | | | | | | | | | | | | | | |
| Temperature | | | | | | | | | | | | | | | | |
| ° F., (° C.) | | | | | | | | | | | | | | | | |
| Plastic | 156 | (0.156) | 87 | (0.087) | 151 | (0.151) | 93 | (0.093) | 331 | (0.331) | 294 | (0.294) | 91 | (0.091) | 111 | (0.111) |
| Viscosity (cP | | | | | | | | | | | | | | | | |
| (Pa s)) | | | | | | | | | | | | | | | | |
| Yield Point | 17 | (0.017) | 20 | (0.020) | 13 | (0.013) | 14 | (0.014) | 48 | (0.048) | 63 | (0.063) | 29 | (0.029) | 49 | (0.049) |
| (pounds/100 ft² | | | | | | | | | | | | | | | | |
| (Pa)) | | | | | | | | | | | | | | | | |

| | | | | |
|---|---|---|---|---|
| UCA time to | 03:48 | 03:12 | 02:30 | 02:47 |
| 50 psi | | | | |
| (345 KPa) | | | | |
| Compressive | 2051 (14147) | | 2670 (16458) | 4018 (27704) |
| Strength at 12 | | | | |
| hours Psi | | | | |
| (KPa) | | | | |
| Static settling | 0.70% | 1.60% | 6.20% | 2.97% |
| Dynamic | 0.50% | 0.05% | 0% | 3.20% |
| settling | | | | |
| Time to mix in | 20 | 23 | No vortex after | 30 |
| dry weighting | | | 45 sec low or | |
| agent and | | | high speed | |
| achieve vortex | | | | |
| Low speed | | | | |
| (seconds) | | | | |

From both sets of results it will be apparent that good free water values were produced across all the formulations tested. The plastic viscosity and yield point values indicate a clear improvement over hematite for the slurries containing barite as made by the present invention. The settling tests indicate a lower tendency for slurries E, F, I, and J to settle and segregate, compared with Slurries G, H, K and L. The ability to easily mix the slurries of the present invention into a cement slurry is also apparent.

1-40. (canceled)

41. A weighting agent composition for use in a cement slurry for downhole operations in a subterranean well, the composition comprising:
a finely divided solid weighting agent; and
a dispersant comprising a sulphonic acid, salt or derivative thereof, the sulphonic acid having the general formula I:
-[A(OSOO⁻M⁺)-B-A′(OSOO⁻M⁺)]ₙ- (I)
wherein A and A′ are each an aromatic moiety;
B is an aliphatic moiety;
OSOO⁻M⁺ is a solubilising group consisting of sulphonic acid, a salt or derivative thereof; and
n is an integer of at least 2.

42. The weighting agent composition according to claim 41, wherein the finely divided solid weighting agent is coated in the dispersant.

43. The weighting agent composition according to claim 42, wherein the weighting agent is prepared by milling in the presence of the dispersant.

44. The weighting agent composition according to claim 41, wherein the finely divided solid weighting agent comprises one or more metal salts of a Group II metal or a transition metal.

45. The weighting agent composition according to claim 44, wherein the metal salt is a salt of calcium, strontium, barium, manganese, iron or titanium.

46. The weighting agent composition according to claim 44, wherein the metal salt is an oxide, a sulphite, a sulphate or a carbonate.

47. The weighting agent composition according to claim 44, wherein the metal salt is selected from barites, ilmenites, strontium carbonate and hematite.

48. The weighting agent composition according to claim 41, wherein the finely divided weighting agent has a D₅₀ of less than 2 microns.

49. The weighting agent composition according to claim 48, wherein the finely divided weighting agent has a D₅₀ of less than 1 micron.

50. The weighting agent composition according to claim 41, wherein the finely divided weighting agent has a particle size distribution such that at least 95% by weight of the particles have a diameter less than 2 microns.

51. The weighting agent composition according to claim 41, wherein A and A′ are independently selected from phenol, naphthalene, anthracene, phenanthrene, melamine, pyridine, pyrazine, imidazole, pyrazole, oxazole, thiophene, isomers thereof, and their benzannulated derivatives.

52. The weighting agent composition according to claim 41, wherein B is an alkyl group having from 1 to 20 carbon atoms.

53. The weighting agent composition according to claim 41, wherein M⁺ is an alkali metal ion or an alkaline earth metal ion.

54. The weighting agent composition according to claim 41, wherein n is from 2 to 15.

55. The weighting agent composition according to claim 41, wherein the compound of formula I is a sulphonated polycyclic aromatic hydrocarbon-acetaldehyde condensate polymer or a sulphonated melamine acetaldehyde condensate polymer.

56. The weighting agent composition according to claim 55, wherein the compound of formula I is a sulphonated naphthalene formaldehyde condensate polymer or a sulphonated melamine formaldehyde condensate polymer.

57. The weighting agent composition according to claim 41, wherein the compound of formula I is present in an amount of up to 2% by weight.

58. The weighting agent composition according to claim 41, wherein the composition is a dry composition having a moisture content of less than 2% by weight.

59. The weighting agent composition according to claim 41, wherein the composition is a slurry.

60. A method for preparing a weighting agent composition for use in a cement slurry for downhole operations in a subterranean well, the method comprising:
preparing a finely divided solid weighting agent; and
combining the solid weighting agent with a dispersant comprising a sulphonic acid, salt or derivative thereof, the sulphonic acid having the general formula I:
-[A(OSOO⁻M⁺)-B-A′(OSOO⁻M⁺)]ₙ- (I)
wherein A and A′ are each an aromatic moiety;
B is an aliphatic moiety;
OSOO⁻M⁺ is a solubilising group consisting of sulphonic acid, a salt or derivative thereof; and
n is an integer of at least 2.

61. The method according to claim 60, wherein dispersant is combined with the finely divided weighting agent during its preparation.

62. The method according to claim 60, wherein the finely divided weighting agent is prepared by milling.

63. The method according to claim 62, wherein dispersant is combined with the weighting agent before and/or during milling.

64. A method of preparing a finely divided weighting agent, the method comprising milling a weighting agent starting material in the presence of a dispersant comprising a sulphonic acid, salt or derivative thereof, the sulphonic acid having the general formula I:
-[A(OSOO⁻M⁺)-B-A′(OSOO⁻M⁺)]ₙ- (I)
wherein A and A′ are each an aromatic moiety;
B is an aliphatic moiety;
OSOO⁻M⁺ is a solubilising group consisting of sulphonic acid, a salt or derivative thereof; and
n is an integer of at least 2.

65. A cement slurry comprising a weighting agent composition comprising:
a finely divided solid weighting agent; and
a dispersant comprising a sulphonic acid, salt or derivative thereof, the sulphonic acid having the general formula I:
-[A(OSOO⁻M⁺)-B-A′(OSOO⁻M⁺)]ₙ- (I)
wherein A and A′ are each an aromatic moiety;
B is an aliphatic moiety;
OSOO⁻M⁺ is a solubilising group consisting of sulphonic acid, a salt or derivative thereof; and
n is an integer of at least 2.

66. A method of cementing a subterranean well comprising providing in the well a cement slurry comprising a weighting agent composition comprising:
a finely divided solid weighting agent; and
a dispersant comprising a sulphonic acid, salt or derivative thereof, the sulphonic acid having the general formula I:
-[A(OSOO⁻M⁺)-B-A′(OSOO⁻M⁺)]ₙ- (I)
wherein A and A′ are each an aromatic moiety;
B is an aliphatic moiety;
OSOO⁻M⁺ is a solubilising group consisting of sulphonic acid, a salt or derivative thereof; and
n is an integer of at least 2.
